(19) United States
(12) Patent Application Publication
(10) Pub. No.: US 2006/0090462 A1
(43) Pub. Date: May 4, 2006

(54) Energy regeneration system for working machinery

(76) Inventor: Kazunori Yoshino, Kobe (JP)

Correspondence Address: Michael B. McNeil;Liell & McNeil Attorneys PC, P.O. Box 2417, Bloomington, IN, 47402, US

(21) Appl. No.: 11/299,402

(22) Filed: Dec. 12, 2005

Related U.S. Application Data
(63) Continuation-in-part of application No. 10/714,171, filed on Nov. 14, 2003.

(51) Int. Cl. F16D 31/02

(52) U.S. Cl. 60/468

(57) ABSTRACT

A method and apparatus to improve regeneration efficiency when regenerating the energy of discharge fluid from a fluid pressure actuator as electrical energy. In a flow rate control line 15, which finctions as a discharge flow path for oil discharged from a head side oil chamber 1c of a hydraulic cylinder 1, is provided a displacement variable regenerating hydraulic motor 20, where controlling the displacement of the regenerating hydraulic motor 20 allows the flow rate of discharge oil from the hydraulic cylinder head side oil chamber 1c to be controlled. A generator 21, which generates electric power due to the rotation of the regenerating hydraulic motor 20, is further provided.

### CROSS-REFERENCE TO RELATED APPLICATIONS

This application is a continuation-in-part of U.S. patent application Ser. No. 10/714171, filed Nov. 14, 2003.

### TECHNICAL FIELD

The present disclosure relates to a technical field of an energy regeneration system for working machinery comprising a fluid pressure actuator, in which the energy of fluid discharged from the fluid pressure actuator is regenerated.

### BACKGROUND

In general, working machinery such as hydraulic excavators are provided with various kinds of fluid pressure actuators which are operated by pressurized fluid from pumps. There have conventionally been known techniques for regenerating the energy of fluid discharged from the fluid pressure actuators such as, in the case that the fluid pressure actuators are hydraulic cylinders, a technique in which is provided a regeneration circuit for supplying part of the oil discharged from a head side oil chamber of each hydraulic cylinder to a rod side oil chamber. In another technique, the energy of oil discharged from each hydraulic cylinder is recovered in an accumulator.

However, in accordance with techniques including a regeneration circuit, although part of the discharge oil from the head side oil chamber of the hydraulic cylinder can be regenerated, much of the oil is diverted into an oil tank directly, as a result of a problem in poor energy regeneration efficiency. Meanwhile, the technique including the accumulator can require a large energy storage capacity in comparison with other energy storage means such as a battery, and further has a shorter energy storage time.

As an improvement measure, Japanese Published Unexamined Patent Application No. 2002-195218 proposes a technique for regenerating and storing the energy of fluid discharged from a pressure actuator as electrical energy. This technique provides a turbine, which is driven rotationally by the inflow of discharge oil from a hydraulic cylinder, in a discharge flow path. The driving force of the turbine allows a generator to generate electrical energy, and therefore the energy of discharge oil can be regenerated and stored efficiently as electrical energy, and further the electrical energy can be utilized as an alternative power source to an engine, resulting also in an environmentally-friendly technique.

Meanwhile, working machinery such as a hydraulic excavator is generally arranged in such a manner that the flow rate of oil discharged from a hydraulic cylinder is controlled by a control valve which performs meter-out control based on the amount of throttle. In particular, the technique disclosed in the above-referenced patent application provides a turbine, which is driven rotationally by the inflow of discharge oil, on the downstream side of such a control valve. Therefore, before the turbine is rotated to regenerate energy, the control valve throttles the discharge oil from the hydraulic cylinder to increase its temperature and thereby consume energy, resulting in a problem of lower energy regeneration efficiency.

The present disclosure has been made in consideration of the above-described circumstances and with a view to solving the problems.

### SUMMARY OF THE DISCLOSURE

In one aspect, the present disclosure provides working machinery including a fluid pressure actuator adapted to operate by supplying/discharging fluid, characterized in that a displacement variable regenerating fluid pressure motor is provided in a discharge flow path for fluid discharged from the fluid pressure actuator, where controlling the displacement of the regenerating fluid pressure motor allows the flow rate of discharge fluid from the fluid pressure actuator to be controlled, and wherein an energy regeneration device for regenerating the energy of discharge fluid, which rotates the regenerating fluid pressure motor, as electrical energy is provided.

In another aspect, the present disclosure provides a work machine. The work machine includes an engine, and a hydraulic system which includes a hydraulic pump, a hydraulic actuator coupled with the hydraulic pump and having first and second supply/discharge ports, and a discharge flow line from the hydraulic actuator. The work machine further includes a variable displacement hydraulic motor fluidly disposed between the first and second supply/discharge ports and being exposed to a fluid pressure of the discharge flow line, said variable displacement hydraulic motor being configured to control a flow rate of discharge fluid from the hydraulic actuator. A energy regeneration device is also provided and operably coupled with the variable displacement hydraulic motor, the energy regeneration device being configured to supply power for operating at least one of the engine and the hydraulic pump.

In still another aspect, the present disclosure provides a method of operating a power system of a work machine. The method includes the steps of powering a hydraulic pump at least in part via an internal combustion engine of the work machine, and supplying hydraulic fluid to at least one hydraulic actuator of the work machine via the hydraulic pump. The method further includes the steps of powering an electrical generator of the work machine at least in part via a step of discharging hydraulic fluid through a hydraulic motor disposed at least partially within a fluid discharge line of the at least one hydraulic actuator, and powering the hydraulic pump at least in part via electrical power from the electrical generator.

### BRIEF DESCRIPTION OF THE DRAWINGS

FIG. 1 is a view of an energy regeneration system according to a first embodiment of the present disclosure;

FIG. 2 is a view of an energy regeneration system according to the second embodiment of the present disclosure wherein like elements have like numbers to FIG. 1;

FIG. 3 is a view of an energy regeneration system according to a third embodiment of the present disclosure wherein like elements have like numbers to FIGS. 1 and 2; and

FIG. 4 is a view of an energy regeneration system according to a fourth embodiment of the present disclosure wherein like elements have like numbers to FIGS. 1-3.

### DETAILED DESCRIPTION

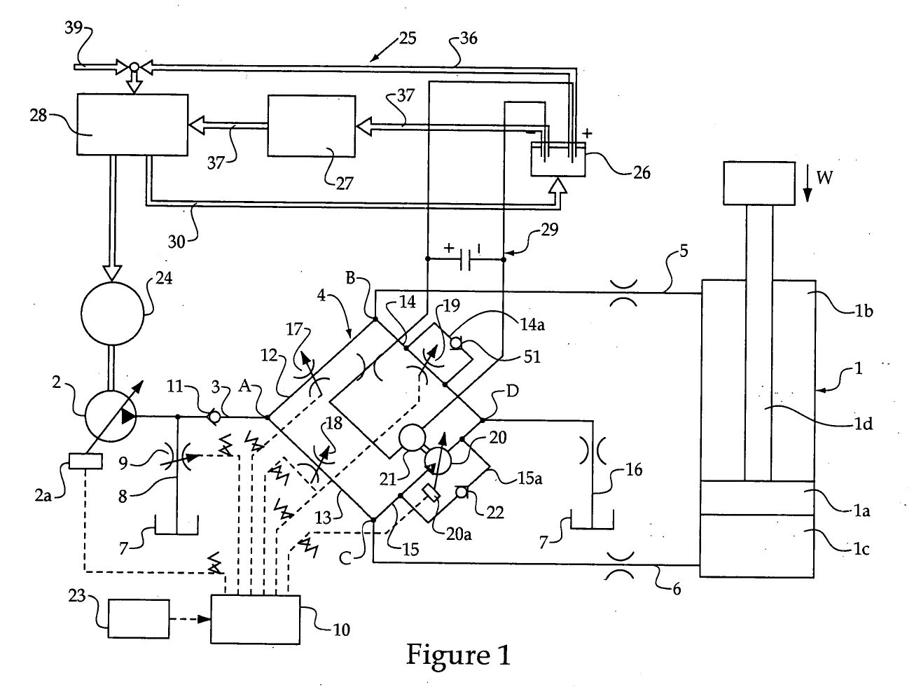

In FIG. 1, the numeral 1 indicates a hydraulic cylinder provided in working machinery such as a hydraulic excavator (e.g. a boom hydraulic cylinder for moving a boom installed in a hydraulic excavator vertically), the hydraulic cylinder 1 being a single-rod type in which a rod side oil chamber 1b and a head side oil chamber 1c are formed on both sides of a piston 1a. The cylinder is arranged in such a manner as to compress when supplying pressure oil to the rod side oil chamber 1b and discharging oil from the head side oil chamber 1c to move the piston 1a in the direction of application of a weight load W. Cylinder 1 is further designed to extend when supplying pressure oil to the head side oil chamber 1c and discharging oil from the rod side oil chamber 1b to move the piston 1 a in the opposite direction of application of the weight load W.

Also, the numeral 2 indicates a hydraulic pump as a pressure oil supply source to the hydraulic cylinder 1, wherein a hydraulic circuit between the hydraulic pump 2 and the hydraulic cylinder 1 are provided: a discharge line 3 connected to the discharge side of the hydraulic pump 2; a flow rate control circuit 4 connected to the downstream side of the discharge line 3; a rod side line 5 adapted to connect the flow rate control circuit 4 and the rod side oil chamber 1b of the hydraulic cylinder 1; and a head side line 6 adapted to connect the flow rate control circuit 4 and the head side oil chamber 1c of the hydraulic cylinder 1.

In an intermediate part of the discharge line 3 is formed a return line 8 to an oil tank 7 in a branching manner, in the return line 8 is disposed a by-pass valve 9 arranged in such a manner as to operate based on a command from a controller 10 to be described later. Further, in the discharge line 3 is disposed a check valve 11 on the downstream side of a bifurcation point for the return line 8, the check valve 11 preventing the counter flow of oil into the hydraulic pump 2 and the return line 8.

The flow rate control circuit 4 is formed by connecting first, second, third, and fourth flow rate control lines 12, 13, 14, and 15 in a rectangular annular shape, where the discharge line 3 is connected to a connecting part A between the first flow rate control lines 12 and second flow rate control lines 13, the rod side line 5 is connected to a connecting part B between the first flow rate control lines 12 and third flow rate control lines 14, the head side line 6 is connected to a connecting part C between the second flow rate control lines 13 and fourth flow rate control lines 15, and a discharge line 16 reaching the oil tank 7 is connected to a connecting part D between the third flow rate control lines 14 and fourth flow rate control lines 15.

In the first flow rate control line 12 is disposed a rod side meter-in valve 17 adapted to control the flow rate of supply oil from the discharge line 3 to the rod side line 5. In the second flow rate control line 13 is disposed a head side meter-in valve 18 adapted to control the flow rate of supply oil from the discharge line 3 to the head side line 6. In the third flow rate control line 14 is disposed a rod side meter-out valve 19 adapted to control the flow rate of discharge oil from the rod side line 5 to the discharge line 16. The rod side meter-in valve 17, the head side meter-in valve 18, and the rod side meter-out valve 19 are arranged in such a manner as to operate based on commands from the controller 10.

Further, in the fourth flow rate control line 15 is disposed a displacement variable regenerating hydraulic motor 20. The displacement of the regenerating hydraulic motor 20 varies from zero to a predetermined maximum value based on a control command output from the controller 10 to a displacement control means 20a, which allows the flow rate in the fourth flow rate control line 15 to vary from zero to a predetermined maximum value, and then the displacement change of the regenerating hydraulic motor 20 allows the flow rate control (meter-out control) of discharge oil from the head side line 6 to the discharge line 16. Further, a generator 21 is interlockingly connected to the regenerating hydraulic motor 20, where the generator 21 can be driven by the torque of the regenerating hydraulic motor 20 to generate electric power.

In the third and fourth flow rate control lines 14 and 15 are also provided, respectively, the rod side meter-out valve 19, by-pass lines 14a and 15a for by-passing the regenerating hydraulic motor 20, and in the by-pass lines 14a and 15a are disposed, respectively, check valves 51 and 22 adapted to allow oil flow from the discharge line 16 to the rod side line 5 and the head side line 6 but to prevent oil flow in the opposite direction. Thus, oil replenishment from the oil tank 7 is to be made when the rod side line 5 or the head side line 6 becomes a vacuum state.

Meanwhile, the controller 10, which is composed of a microcomputer, etc., receives a command signal output from a control lever 23 for the hydraulic cylinder 1, and then outputs control commands to a displacement control means 2a of the hydraulic pump 2, the by-pass valve 9, the rod side meter-in valve 17, the head side meter-in valve 18, the rod side meter-out valve 19, the displacement control means 20a of the regenerating hydraulic motor 20, etc., based on the command signal.

In respect to control commands output from the controller 10, when the control lever 23 for the hydraulic cylinder 1 is positioned in the stop position (i.e. no operation is performed on the control lever 23), the controller 10 outputs a control command of “Valve Open” to the by-pass valve 9, while outputting control commands of “Valve Close” to the rod side meter-in valve 17, the head side meter-in valve 18, and the rod side meter-out valve 19, and further outputs a control command of “Displacement Zero” to the displacement control means 20a of the regenerating hydraulic motor 20. Thus, oil forcibly sent from the hydraulic pump 2 is to be returned to the oil tank 7 through the return line 8, and since the first to fourth flow rate control line 12 to 15 are in a closed state, no oil is supplied/discharged to/from the hydraulic cylinder 1, and therefore the hydraulic cylinder 1 is stopped.

Meanwhile, when the control lever 23 is operated to be the position that indicates the extension of the hydraulic cylinder 1, the controller 10 outputs a control command of “Valve Close” to the by-pass valve 9, while outputting control commands of “Valve Open” to the head side meter-in valve 18 and the rod side meter-in valve 19, a control command of “Valve Close” to the rod side meter-in valve 17, and further outputs a control command of “Displacement Zero” to the displacement control means 20a of the regenerating hydraulic motor 20. In this case, the amount of opening of the head side meter-in valve 18 and the rod side meter-out valve 19 is controlled in such a manner as to increase/decrease in accordance with the increase/decrease of the operation amount of the control lever 23.

Therefore, oil forcibly sent from the hydraulic pump 2 flows through the discharge line 3 to the second flow rate control line 13, and then the flow rate of the oil is controlled by the head side meter-in valve 18 disposed in the second flow rate control line 13 to be supplied to the head side oil chamber 1c of the hydraulic cylinder 1 through the head side line 6. Meanwhile, discharge oil from the rod side oil chamber 1b flows through the rod side line 5 to the third flow rate control line 14, and then the flow rate of the oil is controlled by the rod side meter-out valve 19 disposed in the third flow rate control line 14 to flow to the oil tank 7 through the discharge line 16. Thus, supplying pressure oil to the head side oil chamber 1c and discharging oil from the rod side oil chamber 1b moves the piston 1a in the opposite direction of application of the weight load W to extend the hydraulic cylinder 1.

Also, when the control lever 23 is operated to be the position that indicates the compression of the hydraulic cylinder 1, the controller 10 outputs a control command of “Valve Close” to the by-pass valve 9, while outputting control commands of “Valve Open” to the rod side meter-in valve 17 and the head side meter-in valve 18, and a control command of “Valve Close” to the rod side meter-out valve 19. In this case, the amount of opening of the rod side meter-in valve 17 is controlled in such a manner as to increase/decrease in accordance with the increase/decrease of the operation amount of the control lever 23. The controller 10 further outputs a control command to the displacement control means 20a of the regenerating hydraulic motor 20 so that the displacement thereof is increased/decreased in accordance with the increase/decrease of the operation amount of the control lever 23.

Therefore, oil forcibly sent from the hydraulic pump 2 flows through the discharge line 3 to the first flow rate control line 12, and then the flow rate of the oil is controlled by the rod side meter-in valve 17 disposed in the first flow rate control line 12 to be supplied to the rod side oil chamber 1b of the hydraulic cylinder 1 through the rod side line 5. Meanwhile, discharge oil from the head side oil chamber 1c flows through the head side line 6 to be divided into the second flow rate control line 13 and the fourth flow rate control line 15 at the connecting part C. Then, the discharge oil flowing in the second flow rate control line 13 merges into pressure oil from the discharge line 3 at the connecting part A to be supplied to the rod side oil chamber 1b of the hydraulic cylinder 1 as regeneration oil through the first flow rate control line 12 and the rod side line 5. On the contrary, the flow rate of the oil in the fourth flow rate control line 15 is controlled by the regenerating hydraulic motor 20 to flow to the oil tank 7 through the discharge line 16. Thus, supplying pressure oil to the rod side oil chamber 1b and discharging oil from the head side oil chamber 1c moves the piston 1a in the direction of application of the weight load W to compress the hydraulic cylinder 1.

Further, rotating the regenerating hydraulic motor 20 disposed in the fourth flow rate control line 15, which functions as a discharge flow path from the hydraulic cylinder 1 when compressing the hydraulic cylinder 1, drives the generator 21 to generate electric power, and the electric power is used for a fuel cell device 25 adapted to feed a motor 24 as a power source for the hydraulic pump 2.

The fuel cell device 25 is composed of an electrolytic cell 26 for electrolyzing water, a hydrogen storage device 27 including hydrogen storing alloy for absorbing hydrogen generated in the electrolytic cell 26, a fuel cell 28, etc. The generator 21 is connected to the electrolytic cell 26 via a power supply path 29. The electrolytic cell 26 electrolyzes water using electric power supplied from the generator 21 to generate hydrogen and oxygen. Then, the hydrogen and oxygen is used as fuel for the fuel cell 28 to generate electric power, and the electric power is supplied to the motor 24 to serve power source for driving the hydraulic pump 2. In this case, storing the hydrogen generated in the electrolytic cell 26 once in the hydrogen storage device 27 allows for long term energy storage. In FIG. 1, numeral 30 indicates a return water path for returning the water generated together with electric power in the fuel cell 28 back to the electrolytic cell 26, and providing the return path 30 allows water to be recycled. Numeral 37 indicates hydrogen flow passages, whereas numeral 36 indicates an oxygen flow passage. Numeral 39 identifies an air inlet.

In addition, because of the arrangement that the amount of hydrogen supplied from the hydrogen storage device 27 to the fuel cell 28 is controlled so that the power generation of the fuel cell 28 can be controlled, output of the motor 24 can be controlled optimally.

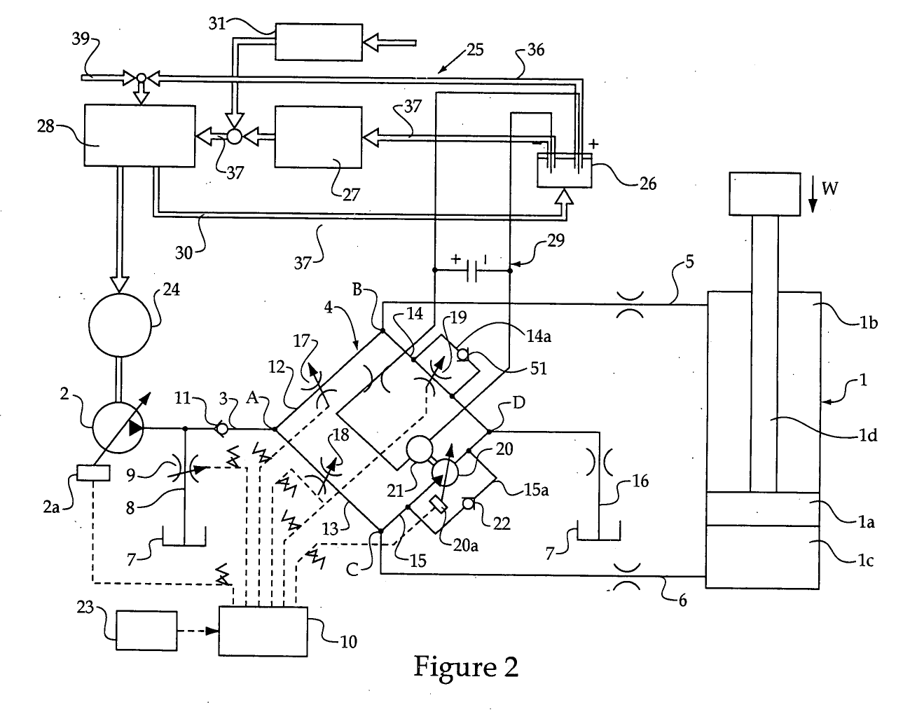

Next, the second to fourth embodiments of the present invention with reference, respectively, to FIG. 2 to FIG. 4 will be described. It is noted that in the second to fourth embodiments, components common to (identical with) those described in the first embodiment are designated by the same reference numerals to omit the description thereof.

First, in respect to the second embodiment shown in FIG. 2, the fuel cell device 25 comprises a reformer 31 for generating hydrogen using chemical fuel such as methanol, ethanol, or LPG as a raw material, where the hydrogen generated by the reformer 31 is merged into hydrogen from the above-mentioned hydrogen storage device 27 to be supplied to the fuel cell 28. Thus providing the reformer 31 allows hydrogen to be supplied to the fuel cell 28 in full measure without increasing the size of the hydrogen storage device 27.

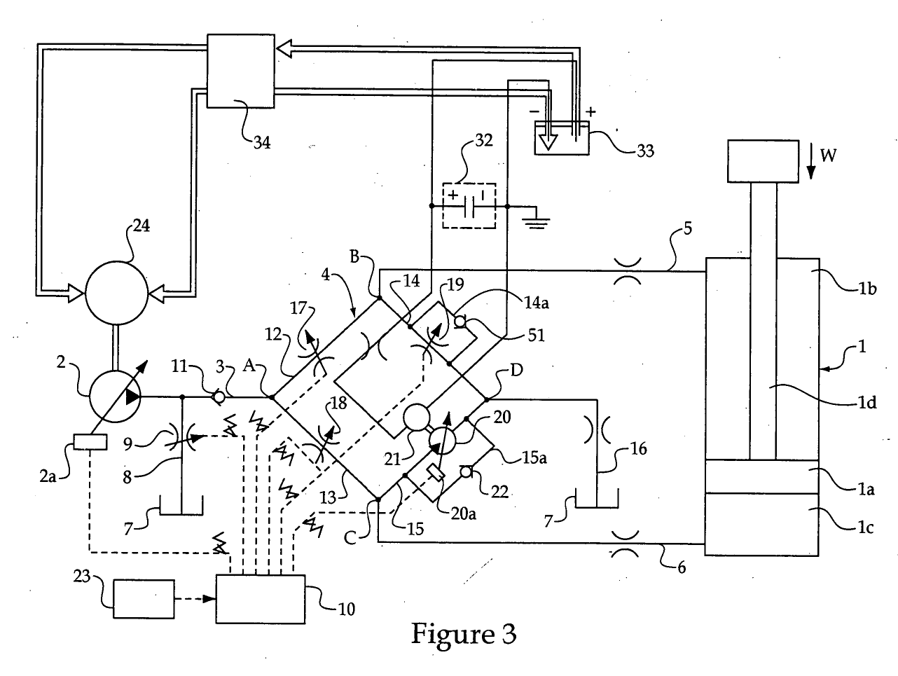

Also, in the third embodiment shown in FIG. 3, no fuel cell device is provided, but a capacitor 32 and an storage battery 33 for storing electric power generated by the generator 21, and an inverter 34 for converting DC power supplied from the storage battery 33 into AC power and for controlling the voltage is provided, where the motor 24 is adapted to be driven by electric power supplied from the inverter 34.

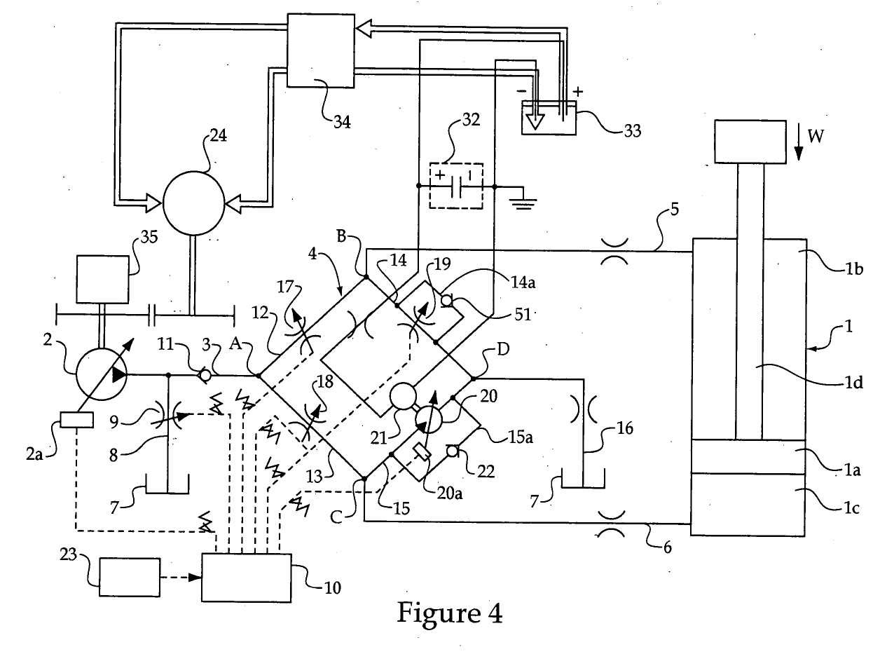

Further, in the first to third embodiments, the motor 24 is used as a power source for driving the hydraulic pump 2. In the case of working machinery including a plurality of hydraulic actuators such as a construction machine, however, where regeneration energy of discharge oil from the hydraulic cylinder 1 runs short of power, or the size of a power storage device such as a storage battery may possibly be increased as large as it is difficult to be mounted on the working machine. Hence, in the fourth embodiment shown in FIG. 4, an engine 35 is mounted as a power source for the hydraulic pump 2, and the motor 24 is used as a auxiliary power source for assisting the engine 35. Thus using the motor 24 as an auxiliary power source allows a reduction in the amount of fossil fuel consumed by the engine 35, which can make a contribution to energy savings, and is also environmentally preferable.

### INDUSTRIAL APPLICABILITY

In the first embodiment as arranged above, when compressing the hydraulic cylinder 1, pressure oil is to be supplied to the rod side oil chamber 1b while oil is to be discharged from the head side oil chamber 1c. For the reason that the discharge oil from the head side oil chamber 1c has high pressure due to the application of the weight load W and that the pressure receiving area of the piston 1a facing the head side oil chamber 1c is larger than that of the piston 1a facing the rod side oil chamber 1b by the cross-sectional area of the rod 1d, a larger amount of oil than that of pressure oil supplied to the rod side oil chamber 1b is to be discharged from the head side oil chamber 1c. Then, part of the discharged oil from the head side oil chamber 1c is supplied to the rod side oil chamber 1b as regeneration oil, as mentioned above, through the head side line 6, the second flow rate control line 13, the first flow rate control line 12, and the rod side line 5, while the rest of the discharge oil is subject to flow rate control (meter-out control) by the displacement variable regenerating hydraulic motor 20 disposed in the fourth flow rate control line 15. The oil is then discharged to the oil tank 7 through the discharge line 16, and the generator 21 is driven by the rotation of the regenerating hydraulic motor 20 to generate electric power. Then, the electric power may be used for the fuel cell device 25 adapted to feed the motor 24 as a power source for the hydraulic pump 2.

As described above, in the present embodiment, the regenerating hydraulic motor 20 is rotated by the inflow of discharge oil from the side oil chamber 1 c of the hydraulic cylinder 1, and the generator 21 generates electric power by the rotational driving of the regenerating hydraulic motor 20, whereby the energy of the discharge oil can be regenerated as electrical energy. The regenerating hydraulic motor 20 not only drives the generator 21 but also controls the flow rate of the discharge oil from the hydraulic cylinder 1.

Accordingly, it becomes unnecessary to provide a control valve for flow rate control in the discharge flow path of the hydraulic cylinder 1, resulting in no energy loss when passing through the control valve, whereby the energy of discharge oil can be regenerated at a high efficiency as electrical energy, which allows an improvement in energy regeneration efficiency.

It is noted that the above embodiments, although exemplifying hydraulic cylinders as fluid pressure actuators, may be applied to a hydraulic motor, and further applicable in scope widely to pressurized fluids of not only hydraulic but also pneumatic fields.

Furthermore, it will be appreciated that the above embodiments, although utilizing electrical energy obtained by regenerating the energy of discharge fluid from the fluid pressure actuators as a power supply source for motors for driving pumps adapted to supply pressurized fluid to the fluid pressure actuators, are not restricted thereto but can be used for various kinds of electric machinery to be mounted on working machinery as a matter of course.

The present description is for illustrative purposes only, and should not be construed to narrow the breadth of the present disclosure in any way. Thus, those skilled in the art will appreciate that various modifications might be made to the presently disclosed embodiments without departing from the intended spirit and scope of the present disclosure. Other aspects, features and advantages will be apparent upon an examination of the attached drawings and appended claims.

What is claimed is:

1. An energy regeneration system for working machinery comprising:
a fluid pressure actuator adapted to operate by supplying or discharging fluid;
a displacement variable regenerating fluid pressure motor disposed in a discharge flow path for fluid discharged from the fluid pressure actuator such that controlling the displacement of the regenerating fluid pressure motor allows the flow rate of discharge fluid from the fluid pressure actuator to be controlled; and
an energy regeneration device for regenerating the energy of discharge fluid as electrical energy at least in part by rotating the regenerating fluid pressure motor.

2. The energy regeneration system for working machinery according to claim 1, wherein the displacement of the regenerating fluid pressure motor is controlled so that the flow rate of discharge fluid from the fluid pressure actuator varies from zero to a predetermined maximum value.

3. The energy regeneration system for working machinery according to claim 2, wherein the flow rate of supply fluid to the fluid pressure actuator is controlled by a supplying flow rate control valve.

4. The energy regeneration system for working machinery according to claim 3, wherein the fluid pressure actuator is a single-rod fluid pressure cylinder, and the regenerating fluid pressure motor is provided in a discharge flow path for fluid discharged from a head side chamber of the fluid pressure cylinder.

5. The energy regeneration system for working machinery according to claim 4, further comprising a controller for receiving an input signal from a fluid pressure actuator operation tool and for outputting a control command to a displacement control means for the regenerating fluid pressure motor based on the input signal.

6. The energy regeneration system for working machinery according to claim 5, further comprising:
a pump adapted to supply pressurized fluid to the fluid pressure actuator; and
a motor operably coupled with the pump;
wherein electrical energy obtained by the energy regeneration device is used as a power supply source for the motor.

7. The energy regeneration system for working machinery according to claim 6, wherein the motor is used as an auxiliary power source for the pump.

8. The energy regeneration system for working machinery according to claim 7, wherein the energy regeneration device comprises:
a power generating means which generates electric power via the rotational driving of the regenerating fluid pressure motor;
a power storage means for storing electric power generated by the power generating means; and
an inverter for converting electric power stored in the power storage means into AC power.

9. A work machine comprising:
an engine;
a hydraulic system including a hydraulic pump, a hydraulic actuator coupled with said hydraulic pump and having first and second supply/discharge ports, and a discharge flow line from said hydraulic actuator;
a variable displacement hydraulic motor fluidly disposed between said first and second supply/discharge ports and exposed to a fluid pressure of said discharge flow line, said variable displacement hydraulic motor being configured to control a flow rate of discharge fluid from said hydraulic actuator; and
an energy regeneration device operably coupled with said variable displacement hydraulic motor and configured to supply power for operating at least one of said engine and said hydraulic pump.

10. The work machine of claim 9 further comprising an electric motor operably coupled with said energy regeneration device and with the at least one of said engine and said hydraulic pump.

11. The work machine of claim 10 wherein said hydraulic pump is operably coupled with said engine.

12. The work machine of claim 11 wherein said electric motor is operably coupled with said hydraulic pump.

13. The work machine of claim 10 wherein:
said hydraulic actuator comprises a linear hydraulic actuator having a rod supply/discharge port and a head supply/discharge port; and
said hydraulic system comprises a low pressure drain and first and second discharge flow lines connecting said rod supply/discharge port and said head supply/discharge port with said low pressure drain, respectively, said variable displacement hydraulic motor being exposed to a fluid pressure of said second discharge flow line between said head supply/discharge port and said low pressure drain.

14. The work machine of claim 13 further comprising a meter out valve disposed at least partially within said first discharge line, and an electronic controller in control communication with said variable displacement hydraulic motor and said meter out valve, said electronic controller being configured to output a displacement control command to a displacement control means of said variable displacement hydraulic motor responsively to the position of an operator input device.

15. The work machine of claim 14 wherein said electronic controller is configured to output a displacement zero command to said displacement control means of said variable displacement hydraulic motor responsively to an actuator extension command from said operator input device.

16. The work machine of claim 15 wherein said electronic controller is configured to output a nonzero displacement command to said displacement control means of said variable displacement hydraulic motor responsively to an actuator compression command from said operator input device corresponding with a position of an operator input device.

17. A method of operating a power system of a work machine comprising the steps of:
powering a hydraulic pump at least in part via an internal combustion engine of the work machine;
supplying hydraulic fluid to at least one hydraulic actuator of the work machine via the hydraulic pump;
powering an electrical generator of the work machine at least in part via a step of discharging hydraulic fluid through a hydraulic motor disposed at least partially within a fluid discharge line of the at least one hydraulic actuator; and
powering the hydraulic pump at least in part via electrical power from the electrical generator.

18. The method of claim 17 wherein the step of powering the hydraulic pump at least in part via electrical power comprises a step of assisting the engine in powering the hydraulic pump via an electric motor coupled with the electrical generator.

19. The method of claim 18 further comprising the step of storing energy generated by the electrical generator in a power storage system, wherein the step of powering the hydraulic pump at least in part via electrical power comprises powering the hydraulic pump via said power storage system.

20. The method of claim 19 wherein the hydraulic motor is a variable displacement hydraulic motor and the at least one hydraulic actuator comprises a linear hydraulic actuator, the method further comprising the step of, during powering of the electrical generator, transferring a selected volume of fluid between a head side chamber and a rod side chamber of the hydraulic actuator at least in part via a step of controlling a displacement of the hydraulic motor and a step of controlling a position of a meter out valve of the hydraulic actuator.
